(19) United States
(12) Patent Application Publication
(10) Pub. No.: US 2024/0198275 A1
(43) Pub. Date: Jun. 20, 2024

(54) MODULAR MULTI-CARTRIDGE STRUCTURAL FRAME WITH WATER MANAGEMENT AND INTEGRATED HEATING FOR SORBENT ARTICLES IN DIRECT AIR CAPTURE SYSTEMS

(71) Applicant: W. L. Gore & Associates, Inc., Newark, DE (US)

(72) Inventors: Christine M. Scotti, Newark, DE (US); Ryan S. Titone, Flagstaff, AZ (US); Edward H. Cully, Clarksville, VA (US)

(21) Appl. No.: 18/545,138

(22) Filed: Dec. 19, 2023

Related U.S. Application Data
(60) Provisional application No. 63/433,968, filed on Dec. 20, 2022.
(60) Provisional application No. 63/611,451, filed on Dec. 18, 2023.

(51) Int. Cl. B01D 53/04; B01D 53/26

(52) U.S. Cl. CPC B01D 53/0415; B01D 53/0438; B01D 53/261; B01D 2257/504

(57) ABSTRACT

A direct air capture (DAC) device includes a plurality of DAC cartridges forming a stacked configuration. Each of the DAC cartridges includes a frame structure having a plurality of perforations facilitating fluid passage therethrough, a plurality of sorbent articles disposed therein and supported by the frame structure, and a plurality of conduits having a plurality of perforations facilitating fluid passage therethrough.

### CROSS REFERENCE TO RELATED APPLICATIONS

This application claims the benefit of U.S. Provisional Application No. 63/433,968, filed Dec. 20, 2022, and U.S. Provisional Application No. 63/611,451, filed Dec. 18, 2023, the disclosures of which are incorporated herein by reference in their entireties for all purposes.

### FIELD

The present disclosure relates to sorbent material composite articles and structures for supporting the sorbent material composite articles during adsorption and desorption processes for direct air capture (DAC) of carbon dioxide (CO₂).

### BACKGROUND

Increasing carbon dioxide (CO₂) levels associated with greenhouse gas emission are shown to be harmful to the environment. As reported by the Climate.gov article “Climate Change: Atmospheric Carbon Dioxide,” the 2019 average CO₂ level in the atmosphere was 409.8 ppm, the highest level that has been noted in the past 800,000 years. The rate of increase of CO₂ in the atmosphere is also reported to be much higher than the rates in previous decades.

In order to limit climate change to acceptable levels, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (BECCS) or direct air capture (DAC) of CO₂.

Capturing CO₂ directly from the atmosphere, referred to as DAC, is one of several means of mitigating anthropogenic greenhouse gas emissions and has attractive economic perspectives as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon the structures for facilitating adsorption and desorption cycles for sorbent material such that these processes may be performed more efficiently.

### SUMMARY

A direct air capture (DAC) device and methods of controlling the same are disclosed herein. In one example (“Example 1”), the DAC device includes a plurality of cartridges forming a stacked configuration. Each cartridge has a frame structure having a plurality of first perforations facilitating a first directional fluid passage therethrough, a plurality of sorbent articles disposed therein and supported by the frame structure, and a plurality of conduits having a plurality of second perforations facilitating a second directional fluid passage therethrough.

In another example (“Example 2”) further to Example 1, the first perforations facilitate flow of air therethrough, and the second perforations facilitate flow of desorbing media therethrough.

In another example (“Example 3”) further to Example 2, the plurality of cartridges are disposed with gaps located between neighboring cartridges to facilitate flow of the desorbing media into the cartridges from each of the gaps.

In another example (“Example 4”) further to Example 3, the gaps facilitate intermixing of the flow of air to provide mixing or flow disturbance into the flow of air.

In another example (“Example 5”) further to Example 4, the mixing or flow disturbance of air between a first sorbent article and a second sorbent article of the plurality of sorbent articles increases an amount of CO₂ being captured by the second sorbent article as compared to the first sorbent article.

In another example (“Example 6”) further to Example 3, the gaps provide locations to facilitate exiting of water from within the sorbent articles disposed in the cartridges.

In another example (“Example 7”) further to any preceding Example, the cartridges are angled at an angle from 1 to 45 degrees with respect to a horizontal axis.

In another example (“Example 8”) further to any preceding Example, the DAC device further includes a perforation control mechanism operatively coupled with the perforations of the cartridges and configured to control opening and closing of the perforations.

In another example (“Example 9”) further to any preceding Example, the DAC device further includes a plurality of integrated flexible resistive heaters disposed between the frame structure of the cartridge and the sorbent articles.

In another example (“Example 10”) further to any preceding Example, the plurality of cartridges comprise at least a first type of cartridge and a second type of cartridge, and the first type of cartridge includes a first type of sorbent article and the second type of cartridge includes a second type of sorbent article different from the first type.

In another example (“Example 11”) further to any preceding Example, the plurality of cartridges are compartmentalized along one plane.

In another example (“Example 12”) further to any one of Examples 1-11, the plurality of cartridges are compartmentalized along two planes.

In one example (“Example 13”), a direct air capture (DAC) device includes: a plurality of cartridges disposed adjacent to each other and further disposed to receive an incoming flow having a first flow at a first flowrate and a second flow at a second flowrate less than the first flowrate. The plurality of cartridges include a first cartridge type having a first type of sorbent suitable for the first flowrate and a second cartridge type having a second type of sorbent suitable for the second flowrate. The first cartridge type is disposed within the plurality of cartridges to engage the first flow and wherein the second cartridge type is disposed within the plurality of cartridges to engage the second flow.

In another example (“Example 14”) further to Example 13, the second cartridge type is disposed at a peripheral edge of the plurality of cartridges as viewed from the incoming flow.

In one example (“Example 15”), a direct air capture (DAC) device includes: a plurality of cartridges including upstream cartridges and downstream cartridges, the upstream cartridges disposed to receive an incoming flow and to be interposed between the incoming flow and the downstream cartridges. The upstream cartridges have a first type of sorbent suitable for engaging the incoming flow, and the downstream cartridges have a second type of sorbent suitable for engaging the incoming flow after that flow passes through the upstream cartridges.

In another example (“Example 16”) further to Example 15, the plurality of cartridges further includes midstream cartridges disposed between the upstream cartridges and the downstream cartridges.

In another example (“Example 17”) further to Example 16, the second type of sorbent is further suitable for engaging the incoming flow after that flow passes through the midstream cartridges.

In one example (“Example 18”), a direct air capture (DAC) device includes: a plurality of cartridges having an upstream surface receiving an incoming flow and a downstream surface through which the incoming flow exits the plurality of cartridges, the plurality of cartridges further defining a flow path extending between the upstream surface and the downstream surface, the flow path configured to receive the incoming flow and direct the incoming flow to the downstream surface. The plurality of cartridges further define at least one gap disposed between the upstream and downstream surfaces, the at least one gap defining a traversing flow between the plurality of cartridges.

In another example (“Example 19”) further to Example 18, the at least one gap interrupts the flow path with surfaces that disrupt a laminar flow property of the traversing flow.

In another example (“Example 20”) further to Example 18, the at least one gap temporarily interrupts the flow path with surfaces that cause the traversing flow to travel in a direction away from the downstream surface.

In another example (“Example 21”) further to Example 18, the at least one gap interrupts the flow path with an introduction of an additional incoming flow that joins with the traversing flow.

In another example (“Example 22”) further to Example 18, the at least one gap defines a drain that removes water from the plurality of cartridges.

In another example (“Example 23”) further to Example 22, the at least one gap is disposed between an upstream cartridge of the plurality of cartridges and a downstream cartridge of the plurality of cartridges, the drain being configured to equalize an upstream volume of water contained in the upstream cartridge and a downstream volume of water contained in the downstream cartridge.

In another example (“Example 24”) further to Example 22 or 23, the plurality of cartridges are disposed at an angle to promote a pooling of water in at least one of the plurality of cartridges.

In one example (“Example 25”), a method for removing gaseous carbon dioxide from an atmosphere includes: receiving information about a dispersion of a first quantity of gaseous carbon dioxide into the atmosphere at a first location; initiating a method of separating a second quantity of gaseous carbon dioxide from the atmosphere at a second location, the second quantity being at least a portion of the first quantity, wherein the method of separating includes the use of the device of any one of Examples 1-24; and initiating a reporting of data regarding the second quantity.

In one example (“Example 26”), a method for removing gaseous carbon dioxide from an atmosphere includes: receiving information about a first quantity of gaseous carbon dioxide; separating a second quantity of gaseous carbon dioxide from the atmosphere, the second quantity being at least a portion of the first quantity, wherein the method of separating includes the use of the device of any one of Examples 1-24; and reporting data regarding the second quantity.

In one example (“Example 27”), a method for removing gaseous carbon dioxide from an atmosphere includes: transmitting information about a dispersion of a first quantity of gaseous carbon dioxide into the atmosphere at a first location; requesting initiation of a method of separating a second quantity of gaseous carbon dioxide from the atmosphere at a second location, the second quantity being at least a portion of the first quantity, wherein the method of separating includes the use of the device of any one of Examples 1-24; and receiving a reporting of data regarding the second quantity.

In one example (“Example 28”), a method for removing gaseous carbon dioxide from an atmosphere includes: receiving, from a computing device, a first electronic communication comprising information about a dispersion of a first quantity of gaseous carbon dioxide into the atmosphere at a first location; initiating a separating, by a carbon capture device, of a second quantity of gaseous carbon dioxide from the atmosphere at a second location, the second quantity being at least a portion of the first quantity, wherein the carbon capture device is the device of any one of Examples 1-24; and initiating a reporting of data associated with the carbon capture device regarding the second quantity, wherein the data forms part of a second electronic communication.

In another example (“Example 29”) further to Example 28, the second electronic communication is configured to be transmitted to the computing device.

In another example (“Example 30”) further to Example 28 or 29, the second electronic communication is configured to be transmitted to an additional computing device.

In one example (“Example 31”), a method for removing gaseous carbon dioxide from an atmosphere includes: receiving, from a computing device, a first electronic communication comprising information about a first quantity of gaseous carbon dioxide; separating, by a carbon capture device, a second quantity of gaseous carbon dioxide from the atmosphere, the second quantity being at least a portion of the first quantity, wherein the carbon capture device is the device of any one of Examples 1-24; and reporting, as a second electronic communication, data associated with the carbon capture device regarding the second quantity.

In another example (“Example 32”) further to Example 31, the second electronic communication is configured to be transmitted to the computing device.

In another example (“Example 33”) further to Example 31 or 32, the second electronic communication is configured to be transmitted to an additional computing device.

In one example (“Example 34”), a method for removing gaseous carbon dioxide from an atmosphere includes: transmitting, to a computing device, a first electronic communication comprising information about a dispersion of a first quantity of gaseous carbon dioxide into the atmosphere at a first location; requesting a separating, by a carbon capture device, of a second quantity of gaseous carbon dioxide from the atmosphere at a second location, the second quantity being at least a portion of the first quantity, wherein the carbon capture device is the device of any one of Examples 1-24; and receiving a second electronic communication comprising an indication of a reporting of data associated with the carbon capture device regarding the second quantity.

In another example (“Example 35”) further to Example 34, the second electronic communication is received from the computing device.

In another example (“Example 36”) further to Example 34 or 35, the second electronic communication is received in response to transmitting the first electronic communication.

In one example (“Example 37”), a method for removing gaseous carbon dioxide from an atmosphere includes: receiving information about a dispersion of a first quantity of gaseous carbon dioxide into the atmosphere at a first location; initiating a separating of a second quantity of gaseous carbon dioxide from the atmosphere at a second location, the second quantity being at least a portion of the first quantity, wherein the separating includes the use of the device of any one of Examples 1-24; and initiating a reporting of data regarding the second quantity.

In one example (“Example 38”), a method for removing gaseous carbon dioxide from an atmosphere includes: transmitting information about a dispersion of a first quantity of gaseous carbon dioxide into the atmosphere at a first location; requesting a separating a second quantity of gaseous carbon dioxide from the atmosphere at a second location, the second quantity being at least a portion of the first quantity, wherein the separating includes the use of the device of any one of Examples 1-24; and receiving a reporting of data regarding the second quantity.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is an illustration of a direct air capture (DAC) device with a plurality of cartridges in a stacked configuration as viewed from an angle, with the sorbent articles disposed therein, according to embodiments disclosed herein.

FIG. 1B is a schematic sideview of the DAC device of FIG. 1A during one of the adsorption/desorption cycles, according to embodiments disclosed herein.

FIG. 1C is an expanded view of a portion of FIG. 1B showing a connection formed between neighboring cartridges, according to embodiments disclosed herein.

FIG. 1D is a schematic diagram of a multi-phase process for adsorption and desorption having directions of fluid transport shown with respect to a sorbent assembly, according to embodiments disclosed herein.

FIG. 2A is a schematic sideview of a DAC device during one of the adsorption/desorption processes, according to embodiments disclosed herein.

FIG. 2B is a schematic sideview of a DAC device during another one of the adsorption/desorption processes, according to embodiments disclosed herein.

FIG. 2C is a partial view of a portion of a conduit with a perforation control mechanism implemented therewith, according to embodiments disclosed herein.

FIG. 3 is a schematic sideview of a DAC device with resistive heating elements implemented therein, according to embodiments disclosed herein.

FIG. 4 is a schematic isometric view of a DAC device with different types of sorbent materials implemented in the multi-cartridge structure, according to embodiments disclosed herein.

FIG. 5 is a schematic isometric view of a DAC device with a plurality of cartridges in a stacked configuration with the sorbent articles disposed therein, according to embodiments disclosed herein.

FIG. 6A is a schematic sideview of a DAC device showing flow of air and desorbing media therethrough, according to embodiments disclosed herein.

FIG. 6B is a schematic sideview of a DAC device showing flow of air and desorbing media therethrough, according to embodiments disclosed herein.

FIG. 6C is a schematic sideview of the DAC device of FIG. 6B showing flow of air during an adsorption phase, according to embodiments disclosed herein.

FIG. 6D is a schematic sideview of the DAC device of FIG. 6B showing flow of desorbing media during a desorption phase, according to embodiments disclosed herein.

FIG. 7A is a schematic sideview of the DAC device of FIG. 6A showing water level or water concentration at different portions of the DAC device, according to embodiments disclosed herein.

FIG. 7B is a schematic sideview of the DAC device of FIG. 6B showing water level or water concentration at different portions of the DAC device, according to embodiments disclosed herein.

FIG. 8A is a schematic sideview of the DAC device of FIG. 6A that is further angled and showing water level or water concentration at different portions of the DAC device, according to embodiments disclosed herein.

FIG. 8B is a schematic sideview of the DAC device of FIG. 6B that is further angled and showing water level or water concentration at different portions of the DAC device, according to embodiments disclosed herein.

FIG. 9A is an illustration of a DAC device with a plurality of cartridges stacked along a length of the device as viewed from an angle during an adsorption phase, according to embodiments disclosed herein.

FIG. 9B is an illustration of a DAC device with a plurality of cartridges stacked along a length of the device as viewed from an angle during a desorption phase, according to embodiments disclosed herein.

FIGS. 10A through 10C are schematic cross-sectional views of a DAC cartridge showing airflow and CO₂ molecules therein during operation.

FIG. 11A is a schematic view of the DAC device with desorbing media manifolds, according to embodiments disclosed herein.

FIG. 11B is a schematic view of a desorbing media manifold, according to embodiments disclosed herein.

FIGS. 12A through 12D are angled views of a conduit used in forming the desorbing media manifold in different shapes and configurations, according to embodiments disclosed herein.

FIGS. 13A through 13D are cross-sectional views of the conduits shown in FIGS. 12A through 12D, respectively.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Furthermore, the term “direct air capture (DAC) device” is defined to include examples with a single DAC cartridge and with multiple DAC cartridges (in a stacked configuration, for example, as further explained herein). The term “DAC cartridge” is defined to include a single frame structure (with any suitable framework defining the shape and size of the structure, as further explained herein) that is at least partially filled with sorbent material composite article(s) and can be used for capturing CO₂ directly from the atmosphere. As defined herein, a DAC device is also referred to as a carbon capture device capable of carrying out any method for separating gaseous CO₂ from a gas mixture in the form of ambient air.

### Description of Various Embodiments

The present disclosure relates to devices for use in direct air capture (DAC) to adsorb and separate one or more desired substances from a source stream, such as carbon dioxide (CO₂) from a dilute feed stream, such as air. Such DAC devices may also be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the adsorbed substance.

An example of articles and techniques for DAC includes using an article including a substrate such as a monolith that can support or be coated with a sorbent material. Variations are established by changing the type of substrate and the sorbent that is used. However, these previously established articles and methods present limitations in the ability to efficiently cycle between adsorbing and desorbing states. They also have limitations with respect to the energy required to perform the process.

Many times, swing adsorption is a very energy intense process. Whether Pressure Swing, Temperature Swing or Moisture Swing, energy is needed during many of the phases of operation.

As an example, in Temperature-Vacuum Swing Adsorption (TVSA) for Direct Air Capture (DAC) of CO₂, the adsorption step may require fans to force large volumes of air through an air contactor, such as ceramic monolith or plate-pack having a series of adjacent plates with a spacing therebetween. At a point when the operator deems it useful to begin desorption (usually when the contactor has adsorbed an amount of CO₂), the fans may be turned off or deactivated to terminate the adsorption phase.

Once the adsorption phase terminates, the inlet and outlet of the module are closed, which provides a seal for negative pressure. Next, vacuum may be applied to evacuate air within the module and steam is applied to increase the temperature to the point where the sorbent releases CO₂. This CO₂ is then pumped out of the module space and is further processed to remove humidity. Of the aforementioned processes, the desorption step requires significant energy to heat and then cool the module. During desorption, the temperature in the entire module volume must be increased from ambient (which, depending on geographic location, may be extremely cold) to the temperature which facilitates CO₂ removal from the sorbent. In many cases steam is used for this increase in temperature since steam is efficient at transferring heat to a substance. An object of the present invention is to increase the efficiency of a DAC system by providing a module which is capable of variable volume. As an example, the air contactor or module may have one volume during the adsorption step which allows air to flow through it at a very low pressure, thereby facilitating adsorption of CO₂ and at least a second, reduced volume during the desorption step which provides an energy savings by reducing the amount of volume that needs to be increased in temperature. Reducing the volume will also reduce the energy required to apply negative pressure, although in some cases the negative pressure maybe the force that causes the volume reduction.

Similarly, in moisture swing and pressure swing adsorption processes, it is the desorption step that is typically the most energy intensive. In moisture swing, energy used in moving moisture to the contactor and energy used in drying the contactor once the CO₂ is desorbed from it. In pressure swing, energy is used to apply pressure to the sorbent to cause the CO₂ to release from it. In both cases it may also be beneficial to provide an air contactor or module which is capable of variable volume configurations. Current state air contactors and modules are deficient in this respect.

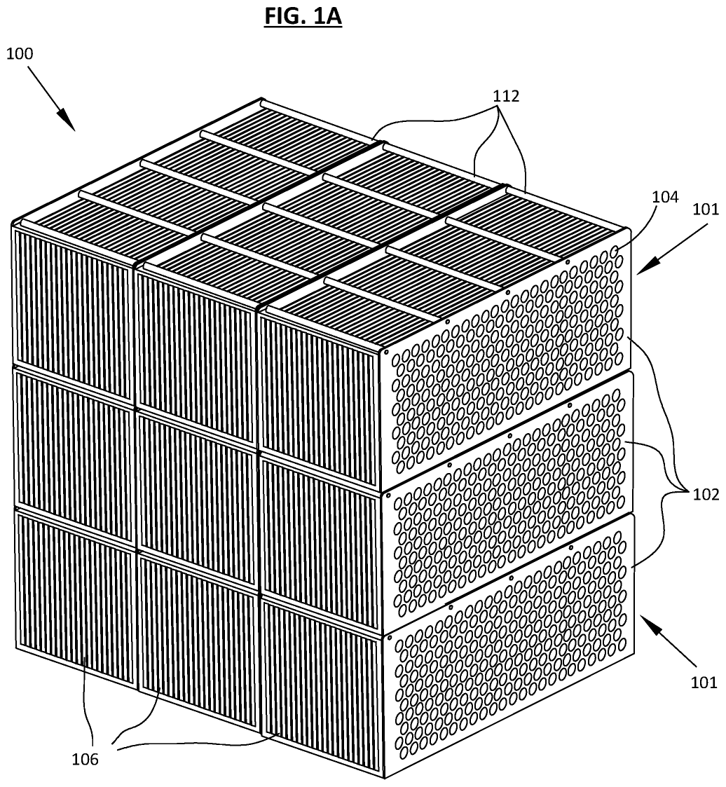

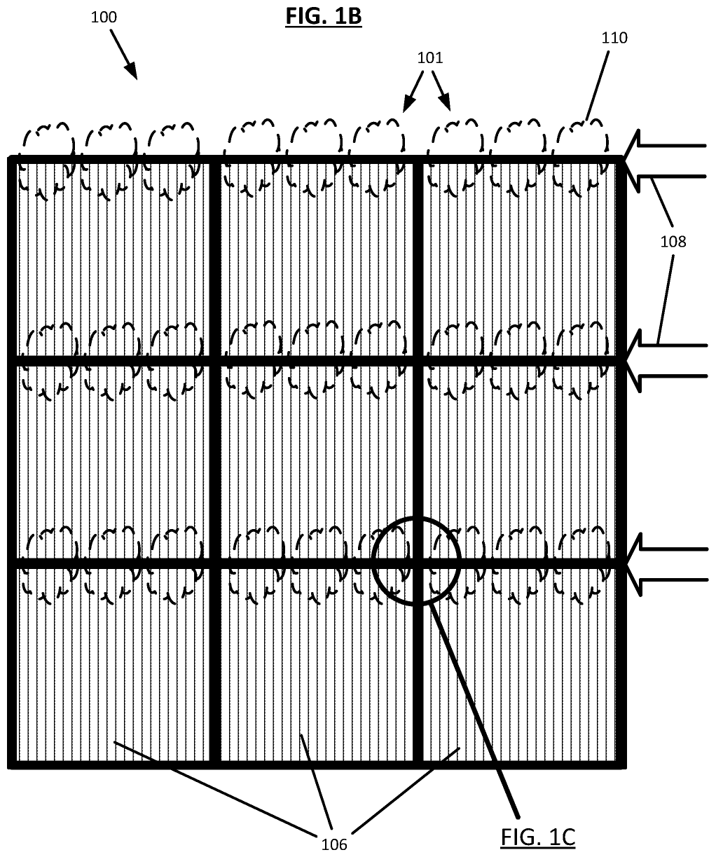

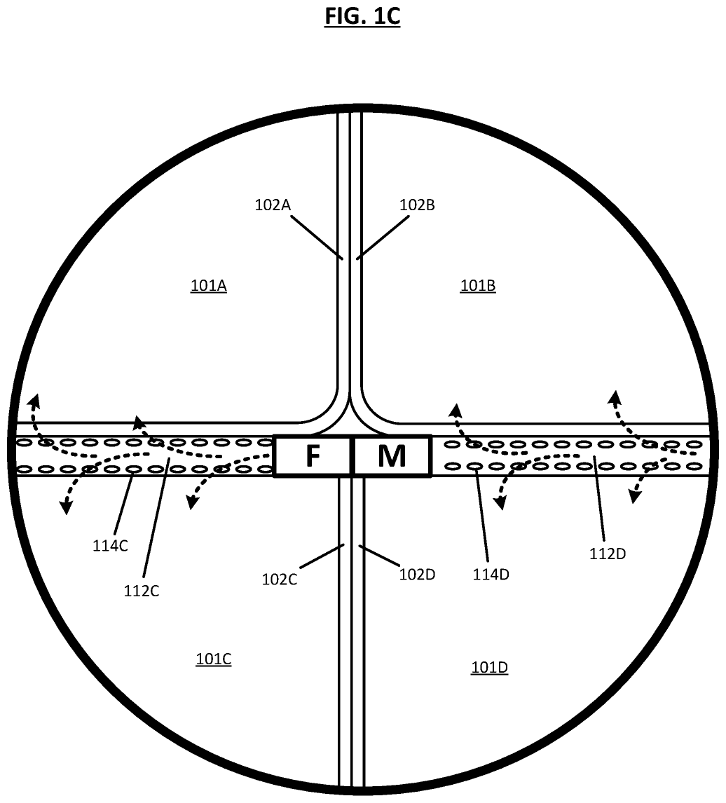

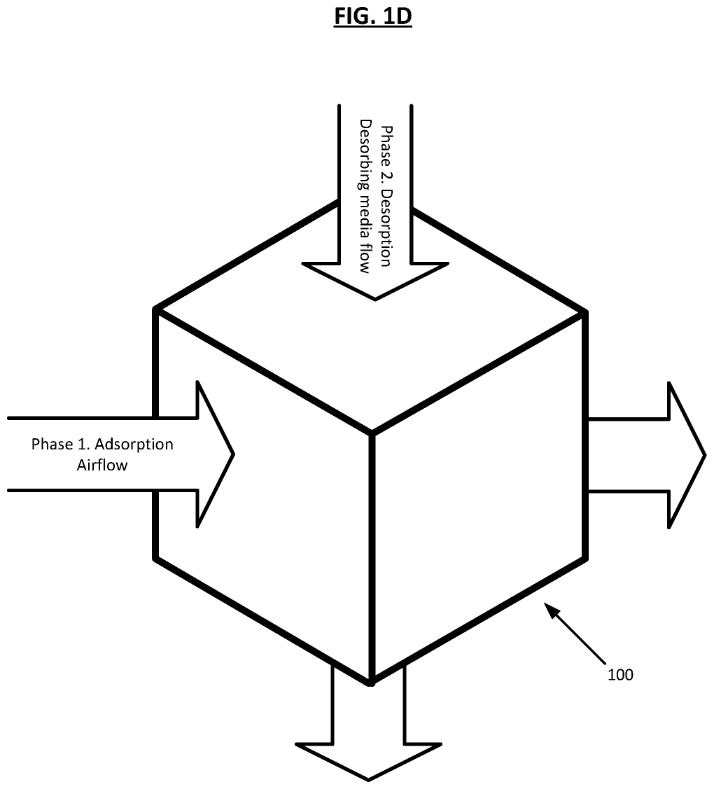

FIGS. 1A and 1B show a DAC device 100 according to an example disclosed herein. The DAC device 100 is a carbon capture device which includes a plurality of sorbent material composite articles 106 capable of facilitating adsorption and desorption of one or more components of a feed stream 108 during each cycle of adsorption and desorption. The feed stream 108 may be the air passing through the DAC device 100, and the one or more components may include CO₂ or any other aforementioned gas molecules, for example. In some examples, desorbing the articles 106 may include submerging the articles 106 into a desorption source such as water (or alternatively using steam or heat as the desorption source in some examples) in order to desorb the CO₂. The feed stream 108 may then escape from a plurality of DAC cartridges 101 as gas or vapor 110. The DAC cartridge 101 as referred to herein may be those disclosed in a co-pending application U.S. application Ser. No. 18/544,769, filed Dec. 19, 2023 (W. L. Gore & Associates, Inc.), the disclosure of which is incorporated herein by reference in its entirety for all purposes. The DAC cartridge 101 may also include sorbent articles such as those disclosed in International Publication Nos. WO 2022/187730 (W. L. Gore & Associates, Inc.) and WO 2022/187733 (W. L. Gore & Associates, Inc.), the disclosures of which are incorporated herein by reference in their entireties for all purposes.

The articles 106 may be held in place within the DAC device 100 (also referred to herein as a DAC assembly) using a frame, a support framework, or a frame structure 102 which includes a plurality of holes or perforations 104 through which fluid such as desorbing media (which in some examples may be one or more of: hot liquid, steam, saturated steam, superheated liquid, or any substance that transfers heat, etc.) is allowed to pass through during the adsorption/desorption processes as explained above. The desorbing media as referred to herein may include those disclosed in U.S. application Ser. No. 18/234,014 (W. L. Gore & Associates, Inc.), the disclosure of which is incorporated herein by reference in its entirety for all purposes. The DAC device 100 includes a plurality of DAC cartridges 101 in a stacked configuration. The articles 106 may be inserted or disposed in and supported by the frame structure 102 to form the DAC cartridge 101, which may be installed in the DAC reactor, in any suitable configuration as further explained herein. The DAC device 100 and assembly, the support framework, and the frame structure 102 may be those disclosed in a co-pending application U.S. application Ser. No. 18/544,769, filed Dec. 19, 2023 (W. L. Gore & Associates, Inc.), the disclosure of which is incorporated herein by reference in its entirety for all purposes. The DAC reactors as referred to herein may include those as further disclosed in International Publication Nos. WO 2021/239747 (Climeworks AG) and WO 2023/104656 (Climeworks AG), the disclosures of which are incorporated herein by reference in its entirety their entireties for all purposes.

When the multiple DAC cartridges 101 are stacked in a stacked configuration to form a multi-cartridge DAC device 100, each DAC cartridge 101 has a frame structure 102 and sorbent articles 106 installed therein, and each cartridge 101 is stackable on top of, as well as side-by-side with, another cartridge 101 with same or similar size, shape, and/or form (e.g., similar dimensions) in forming the multi-cartridge structure or assembly for the DAC device 100, which may be placed inside the DAC reactor. In building the multi-cartridge structure, the DAC device 100 forms a fluid connection between neighboring or adjacent DAC cartridges 101 using couplable conduits as further disclosed herein.

FIG. 1C shows an example of how the fluid coupling may be achieved. Four neighboring DAC cartridges 101A, 101B, 101C, and 101D surround a fluid coupling achieved using a male coupling end “M” and a female coupling end “F” of a tubular construct or conduit 112. For simplicity, the sorbent articles 106 contained in the cartridges are not shown. Each cartridge 101 includes a plurality of conduits 112 extending along a top portion of the frame structure 102 of the cartridge 101, with one end of the conduits 112 having the male coupling end M and an opposing end having the female coupling end F.

The conduit 112 includes a plurality of holes or perforations 114 extending through the wall of the conduit 112, thereby allowing fluid to pass through the conduit 112 and into the surrounding environment. Although not shown, the frame structure 102 also has holes or perforations 104 as described above, such that any fluid passing through the perforations 114 of the conduit 112 also passes through the perforations 104 of the frame structure 102, thereby reaching the sorbent articles 106 disposed therein. The conduit 112C of the cartridge 101C includes the female end F, and the conduit 112D of the cartridge 101D includes the male end M. The fluid flow through the conduits 112C and 112D is shown in dotted arrows. The fluid flowing from the right side (although in some examples the fluid may flow from the left side or from both sides, as suitable) may pass through the conduits 112C and 112D and through the holes or perforations 114C and 114D to escape into the surrounding cartridges 101A through 101D.

The coupling ends M and F may be any suitable type of interference fit components which may form the fluid coupling as well as attaching or affixing together the two components when the DAC cartridges 101 form the stacked configuration as shown. The stacked configuration may be temporary, that is, the stacked cartridges can be decoupled or disassembled after assembly, for example in order to remove or replace certain cartridge(s). The interference fit may include but are not limited to press fit or friction fit. In some examples, the coupling end M may be screwed, pressed, inserted, or otherwise advanced into the receiving end or coupling end F, in order to facilitate the fluid coupling. In further examples, the coupling of mating ends may not be male or female and, alternatively, may be an interposed coupler serving to join one end to the other in a fluid communication.

As shown in FIG. 1D, crossflow of the DAC device 100 is defined by two phases. In a first adsorption phase (Phase 1), air passes into the cartridge that is filled with sorbent articles (sorbent assembly), which is shown as a cube in the figure, in a first direction as shown by the horizontal arrows. During Phase 1, carbon dioxide from the incoming air is captured inside the sorbent assembly. In a second desorption phase (Phase 2) which follows Phase 1, desorbing media passes into the cartridge in a second direction as shown by the vertical arrows. The vertical and horizontal directions are interchangeable. The cartridge or sorbent assembly may cycle between Phase 1 and Phase 2 such that the subsequent Phase 1 following Phase 2 may facilitate drying the sorbent assembly which may be moist or wet from the application of the desorbing media (e.g., steam) during Phase 2. Advantageously, cross-flow facilitates efficient drying of sorbent articles for improved efficiency of adsorption/desorption cycles.

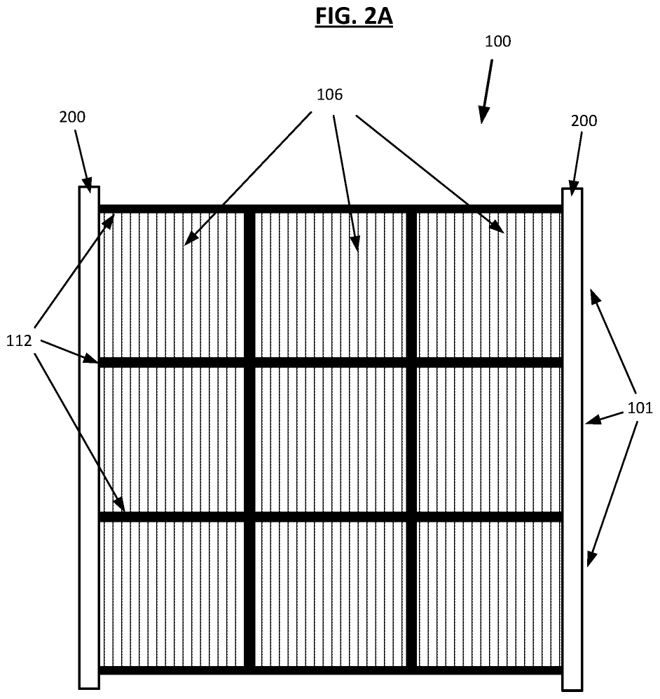

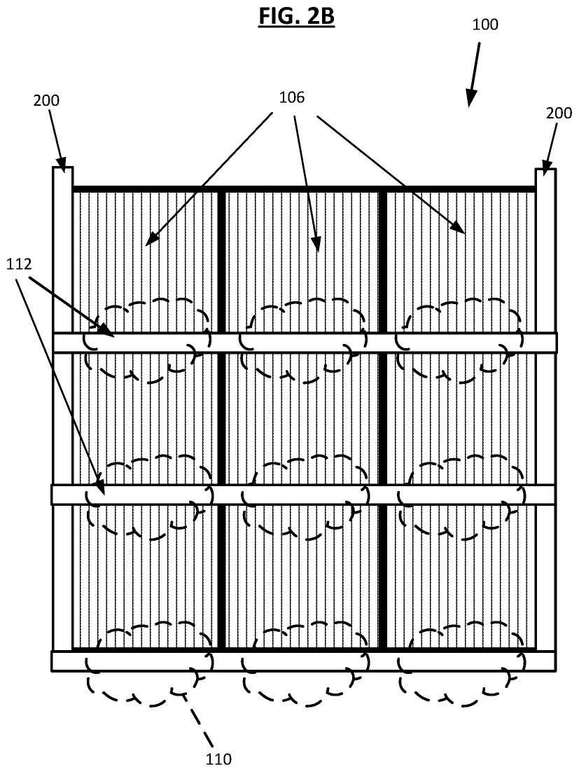

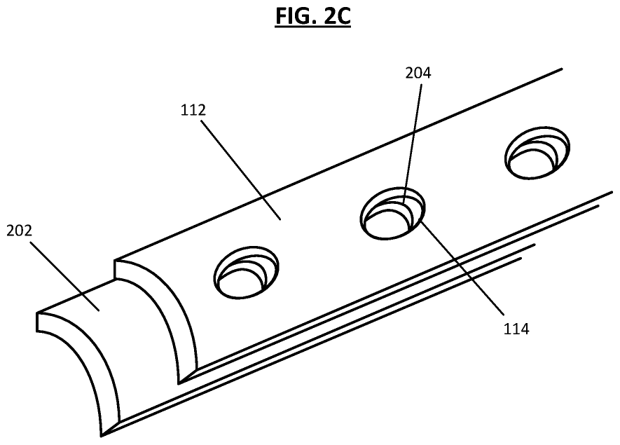

FIGS. 2A and 2B show that, in some examples, the DAC device 100 includes a plurality of stacked DAC cartridges 101 containing sorbent articles 106 therein. For example, the cartridges 101 may include a plurality of rods or pipes with tapped ends as disclosed in the aforementioned U.S. application Ser. No. 18/544,769, and each of the rods or pipes is hollow and defines an internal channel to be as the conduit 112 used during adsorption and desorption processes. In some examples, chilled water may pass through an active insulation mechanism 200 that is attached external to the frame structures 102 of the DAC cartridges 101. The active insulation mechanism may include one or more channels operating to cool down the frame structures in order to cool down the desorbing media and form condensation. Furthermore, hot steam may pass through the rods or pipes to heat up the frame structures in order to heat up the condensation to provide water vapor inside the frame structures. The water vapor may then be provided back into the sorbent articles through holes or openings in the rods or pipes, continuing the adsorption and desorption cycle. In some examples, the openings 114 may be controllable to close or open as needed at different stages during adsorption and desorption.

Beneficially, switching steam supply circuit with chilled water may reduce cycle time. Running steam supply in walls may provide active insulation and reduce condensation. Cooling water is prevented from exiting steam holes. Cartridges may potentially snap into walls to add to a circuit while also providing structural support and assisting the locating of cartridges.

FIG. 2C shows a perforation control mechanism 202 which may be implemented with or coupled with the conduit 112 according to some examples disclosed herein. The conduit 112 has a plurality of openings or perforations 114, which can be opened or closed using the mechanism 202. For simplicity, the figure only shows a portion of the conduit 112 and the mechanism 202 surrounding the relevant perforations 114. In some examples, the mechanism 202 may be a smaller tube which is inserted into and to be disposed within the conduit 112, or a piece of metal having a curvature which aligns with the inner curvature of the conduit 112, for example. The mechanism 202 also includes a plurality of openings or perforations 204 which align with the positions of the perforations 114 of the conduit 112.

As such, when aligned in a first configuration such that the perforations 114 and 204 are in line with each other, fluid may be allowed to pass through the perforations and into the surrounding environment from within the conduit 112. In a second configuration where the perforations 114 and 204 are in a staggered configuration, the wall of the conduit 112 may block the perforations 204 and the wall of the mechanism 202 may block the perforations 114, thereby preventing fluid from flowing therethrough. The user or the device which controls the opening and closing of the perforations may do so by, for example, twisting and/or sliding the mechanism 202 with respect to the conduit 112 in order to switch between the first (open) configuration and the second (closed) configuration. Alternatively, the mechanism 202 may include tabs or flaps which may be activated to open or close the respective perforations 114 in the conduit 112, in order to switch between the first and second configurations.

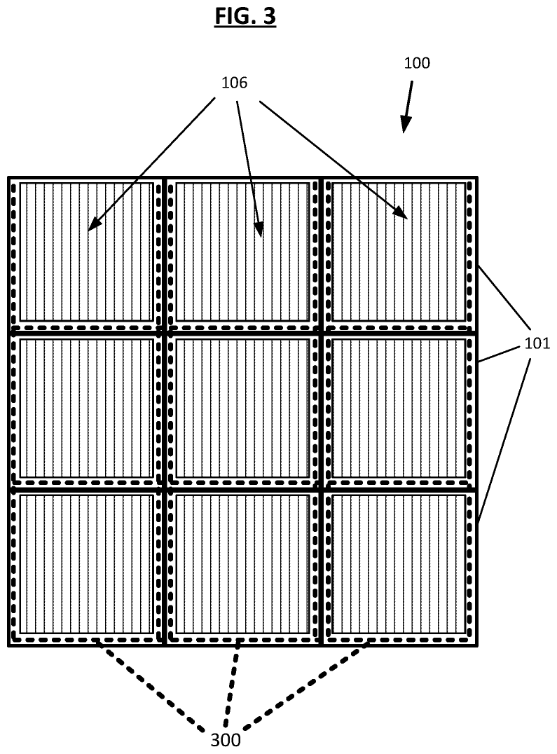

FIG. 3 shows integrated flexible resistive heaters 300 which may be implemented into the DAC cartridges 101. For example, the resistive heaters 300 may be disposed between the frame structure 102 of the DAC cartridge 101 and the sorbent articles 106. The resistive heaters 300 may have holes for allowing fluid passage and may be implemented into each of the DAC cartridges 101 to act as active insulation to reduce the need to heat the individual chambers defined within the frame structure 102. The resistive heaters 300 may be implemented as a jacket component that is configured to be disposed around all or part of the cartridge assembly. Pre-heating may also reduce condensation. Other water management features and/or integrated heating features such as those disclosed in a co-pending application U.S. application Ser. No. 18/544,831, filed Dec. 19, 2023 (W. L. Gore), the disclosure of which is incorporated herein by reference in its entirety for all purposes.

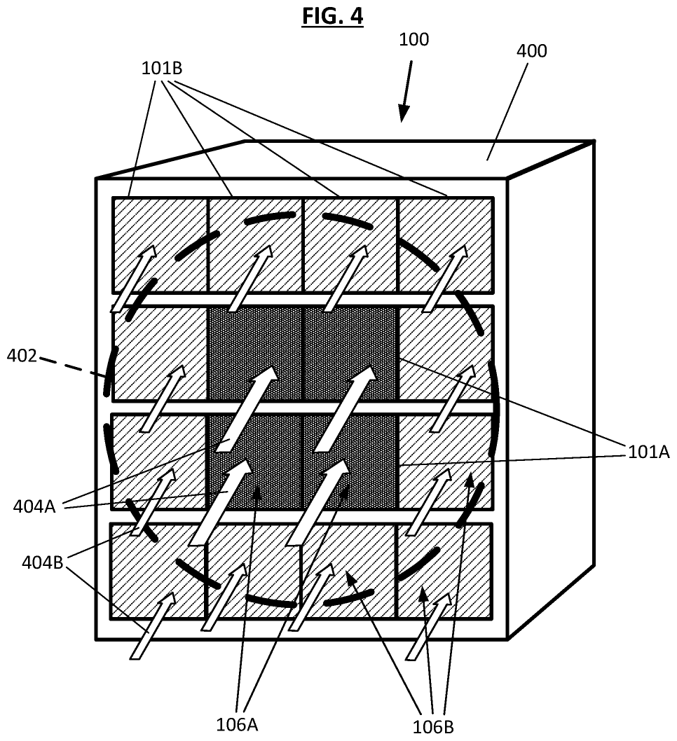

FIG. 4 shows an example of a DAC device 100 in which some of the DAC cartridges 101 contain a different type of sorbent material (in the sorbent articles 106) from one or more other cartridges 101. In some examples, the cartridges 101 are disposed adjacent to each other to receive an incoming flow 404, and also include sorbent articles 106 which may be replaced at different times during the adsorption and desorption process. The incoming flow 404 may include at least: a first flow 404A with a first flowrate (thicker white arrows), and a second flow 404B with a second flowrate (thinner white arrows) that is less than the first flowrate. The cartridges 101 are modular and configurable in that they are individually removable and replaceable. In some examples, the outer cartridges, or cartridges 101B that are positioned along the outer periphery of a DAC reactor housing 400, may contain different sorbent articles (labeled “106B”) from the sorbent articles (labeled “106A”) that are contained within the inner cartridges, or cartridges 101A that are positioned at an inner section with respect to the outer cartridges 101B. The cartridges 101A (first cartridge type) may contain a first type of sorbent (e.g., 106A) that is suitable for the first flowrate, and the cartridges 101B (second cartridge type) may contain a second type of sorbent (e.g., 106B) that is suitable for the second flowrate. As such, the first cartridge type (of 101A) is disposed within the plurality of cartridges to engage the first flow 404A, and the second cartridge type (of 101B) is disposed within the plurality of cartridges to engage the second flow 404B. In some examples, the incoming flow 404 (which includes at least the first flow 404A and the second flow 404B) may be provided via a fan 402 (it is to be understood that the broken circle represents a region of output from the fan 402 which is the inflow into the cartridges 101, as suitable) such that the cartridges closer to the center of the circle receives a flow with a greater flowrate than the cartridges closer to the periphery of the circle. In some examples, the second cartridge type 101B is disposed at a peripheral edge of the plurality of cartridges as viewed from the incoming flow 404.

In some examples, the sorbent articles 106A and 106B may differ from each other in terms of the sorbent materials that are used, the percentage of the article that is coated with a sorbent coating, and/or the spacing or gap between individual sheets or layers of sorbent material, etc. Such example may be implemented when an electric fan (not shown) that is used to facilitate airflow through the DAC reactor has a different shape from that of the DAC reactor housing 400, such as, for example, when the fan has a round shape but the DAC reactor housing 400 has a square shape. As can be appreciated, the selective placement of different types of sorbent materials in the sorbent articles 106 presented in a cartridge assembly enables configurations that compensate for flow non-uniformities when, for example, an inflow driven by a circular fan engages with a square reactor housing. To compensate for variations in fluid flows passing into the reactor, sorbent articles at low-flow edges of the reactor can be selected for properties that perform better with less flow, and sorbent articles at the center of the reactor can be selected for properties that perform better with comparatively greater flow, to thereby provide a sorbent performance that is consistent overall and to avoid the formation of areas in the sorbent assembly that drive excessive or inadequate cycle times.

In some examples, the sorbent articles 106 may be formed in the shape of a sheet or a thin board or sorbent material which may be flexible or rigid and can be inserted into the frame structure 102 to form the DAC cartridge 101. In some examples, each cartridge 101 may have such sorbent sheets arranged differently from one or more other cartridges 101. In some examples, the spacing between adjacent sorbent articles 106 may be different for one or more of the cartridges 101, for example in order to accommodate the different airflow patterns within the DAC reactor. In some examples, different numbers and stacking configuration of the multiple cartridges 101 may be implemented according to the size or inner dimension of the DAC reactor. In another example, the sorbent articles presented at low-flow locations in a DAC reactor can be configured with greater spacing to permit greater flow therethrough whereas sorbent articles presented at high-flow locations in the same DAC reactor can be configured with comparatively less spacing to provide lesser flow therethrough and, altogether, present an overall flow profile that achieves a shorter or more efficient cycle time.

In some examples, the individual DAC cartridges 101 may be removed from the multi-cartridge DAC device 100 and replaced with another cartridge 101, for example when replacing the old sorbent material(s) contained inside the DAC cartridge 101 with new sorbent material(s). The removing and replacing of a DAC cartridge 101 may be performed without removing the entire DAC device 100 from inside the DAC reactor, such that if only one cartridge needs to be removed, it may be removed (and subsequently replaced) without affecting one or more of the other cartridges that form the multi-cartridge DAC device 100. In the example shown, the total height of the DAC device 100 may be 360 mm so as to be sized for a 36 cm reactor, although the DAC device may alternatively scaled as suitable for larger or smaller reactors that are known in the art. It is to be understood that any number of cartridges may be installed or implemented as suitable for the DAC reactor.

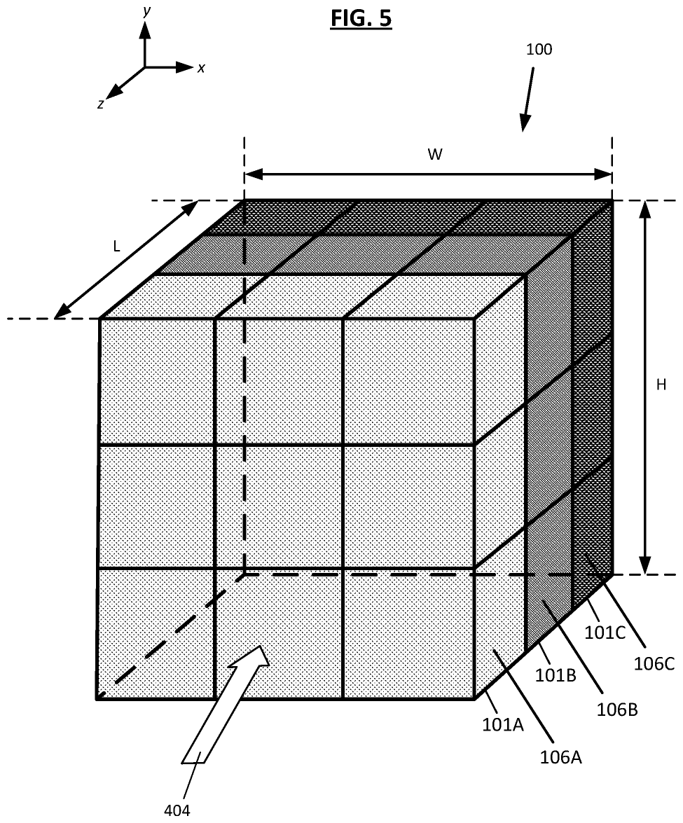

FIG. 5 shows a DAC device 100 that is populated by a plurality of DAC cartridges 101 according to some embodiments. For example, the DAC device 100 may include a plurality of DAC cartridges 101 arranged along length (L), width (W), and/or height (H) of the DAC device. In the figure, the DAC cartridges 101A, 101B, and 101C are disposed side-by-side along the direction of the length (L) of the DAC device 100. The different shadings may show the different types of DAC cartridges being used. For example, a first type of DAC cartridge 101A may include sorbent articles 106A disposed therein that are different from a second type of DAC cartridge 101B with sorbent articles 106B and from a third type of DAC cartridge 101C with sorbent articles 106C, and so on, such that each type of DAC cartridge may include different types or configurations of sorbent article (such as having different sorbent materials and/or having different dimensions) as suitable. As such, the compartmentalizing of the DAC device 100 may occur in one or two planes, where the x-axis may be located along the width (W), y-axis along the height (H), and z-axis along the length (L), in one example. The embodiment shown in FIG. 1A may represent an example of the DAC device 100 that is compartmentalized in one plane, which may be the plane defined by the x-axis/width (W) and the y-axis/height (H), whereas there is no compartmentalizing along the z-axis/length (L). In comparison, the embodiment shown in FIG. 5 may represent an example of the DAC device 100 that is compartmentalized in two planes, because the compartmentalizing takes place along the z-axis/length (L) as well. As can be appreciated, the selective placement of different types of sorbent materials in the sorbent articles 106 in the L direction enables configurations that compensate for variations in the quality of the flows passing through the cartridges when, for example, an incoming flow with a high concentration of a property (like CO₂) is reduced in that property as it passes through earlier cartridges in a sequence of cartridges. To compensate for variations in fluid flows passing through the reactor, sorbent articles at upstream and downstream locations can be selected for properties that perform better at different locations within the received flow, to thereby provide a sorbent performance that is consistent overall and to avoid the formation of areas in the sorbent assembly that drive excessive or inadequate cycle times.

In some examples, the cartridges 101 include upstream cartridges and downstream cartridges, relative to an incoming flow 404. For example, in the example as illustrated in FIG. 5, the set of cartridge 101A may be defined as the upstream cartridges, whereas the set of cartridges 101C may be defined as the downstream cartridges. The set of cartridges 101B located between the upstream and downstream cartridges may be referred to as midstream cartridges. The upstream cartridges 101A are disposed to receive an incoming flow 404 and to be interposed between the incoming flow 404 and the downstream cartridges 101C. The upstream cartridges 101A may have a first type of sorbent (for example, 106A as referred to in FIG. 4) suitable for engaging the incoming flow 404, and the downstream cartridges 101C may have a second type of sorbent (for example, 106B as referred to in FIG. 4) suitable for engaging the incoming flow 404 after the incoming flow 404 passes through the upstream cartridges 101A. In some examples, the second type of sorbent may be further suitable for engaging the incoming flow 404 after the incoming flow 404 passes through the midstream cartridges 101B.

Advantageously, the implementation of multiple smaller units (cartridges) in a DAC device may include, but are not limited to, the capability of using different types or dimensions of contactors/sorbent articles within the same DAC reactor. In some examples, the multi-cartridge implementation beneficially allows for alternate flow profiles, pressure drops, or alternate air gaps in the design of the DAC device. Additionally, the multi-cartridge implementation may be beneficial for facilitating repairs of damaged or deficient units/cartridges as well as damaged portions of the unit, by replacing only the damaged or deficient part(s) without having to replace the entire device. The multi-cartridge implementation may provide benefits in the ergonomics as well as logistics of the DAC device, since the DAC device may be manufactured and/or transported in smaller sizes and assembled at the reactor.

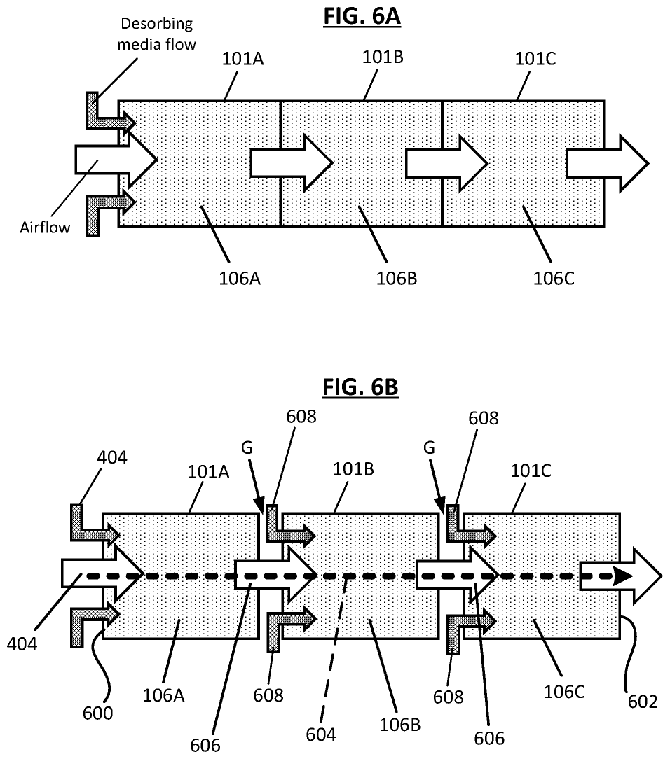

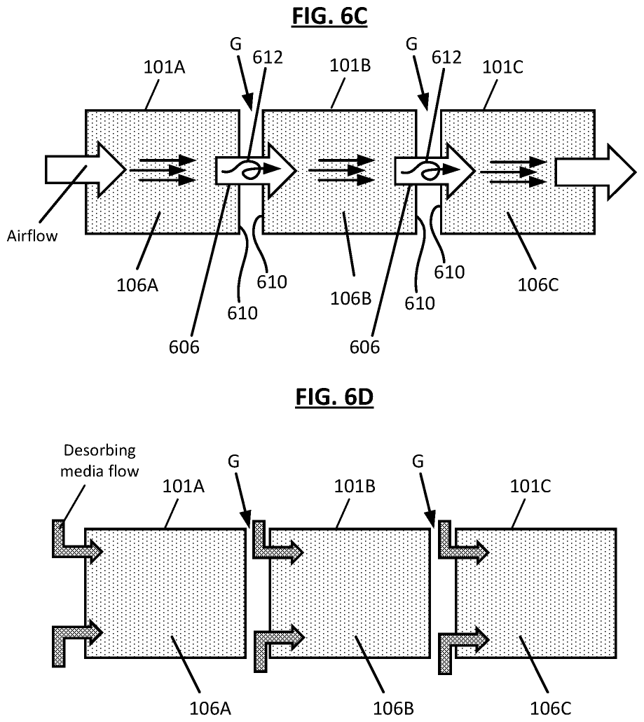

FIGS. 6A and 6B show the three cartridges 101A, 101B, and 101C as viewed along the direction of the z-axis of FIG. 5 (e.g., lengthwise along the length L) in different concepts. In these figures, the airflow occurs during adsorption phases of the adsorption-desorption cycle, and the desorbing media flow occurs during desorption phases of the adsorption-desorption cycle.

In FIG. 6A, the cartridges are disposed next to each other without any gap or spacing (gapless) between the cartridges such that the desorbing media flow and the airflow enters the cartridges from the opening of the first cartridge 101A, and the flow continues from the first cartridge 101A to the second cartridge 101B and then to the third cartridge 101C.

In FIG. 6B, there is a gap “G” between neighboring cartridges (e.g., a gap between cartridges 101A and 101B and another gap between cartridges 101B and 101C) such that each gap G provides an additional entryway for the desorbing media as shown by the shaded arrows, while allowing the airflow as shown by the white arrows to pass through the cartridges. The gaps G may be maintained by placing solid components such as separators between the neighboring cartridges. In the gap-implemented example, the gaps may beneficially allow desorbing media to flow into the sorbent articles stored inside the cartridges from multiple regions throughout the cartridges, thereby reducing the time necessary to heat the sorbent articles to a predetermined temperature. The gap G may have a width or distance of from 1 mm to 5 mm, from 5 mm to 10 mm, from 10 mm to 15 mm, from 15 mm to 20 mm, from 20 mm to 25 mm, from 25 mm to 30 mm, from 30 mm to 35 mm, from 35 mm to 40 mm, from 40 mm to 45 mm, or from 1 mm to 45 mm.

For example, referring to FIG. 6B, the cartridges 101A, 101B, and 101C (collectively referred to herein as the cartridges 101) may have an upstream surface 600 that receives an incoming flow 404 and a downstream surface 602 through which the incoming flow 404 exits the cartridges 101. The cartridges 101 may further define a flow path 604 (shown using a broken arrow) extending between the upstream surface 600 and the downstream surface 602. The flow path 604 may receive the incoming flow 404 and direct the incoming flow 404 to the downstream surface 602, thus defining a general direction in which the incoming flow 404 is to flow through the cartridges 101. In some examples, the cartridges 101 may further define at least one gap G disposed between the upstream surface 600 and the downstream surface 602, where the gap G defines a traversing flow 606 between the cartridges 101, such as between the neighboring or adjacent cartridges.

FIG. 6C shows an adsorption phase in the gap-implemented example of FIG. 6B. As air flows into the first DAC cartridge 101A and passes through the cartridge, airflow becomes laminar as shown by the three straight arrows shown within. As the airflow travels from the first DAC cartridge 101A to the second DAC cartridge 1011B, the gap G facilitates intermixing of the airflow, thereby adding mixing or flow disturbance into the airflow as shown by the swirling arrow shown within the white arrow. The added mixing or flow disturbance allows the CO₂ remaining in the airflow to be more readily and easily captured by the sorbent articles 106B in the second DAC cartridge 101B. Similarly, the gap G between the second DAC cartridge 101B and the third DAC cartridge 101C may operate similarly to facilitate intermixing and adding mixing or flow disturbance into the airflow as the airflow travels from the second DAC cartridge 101B to the third DAC cartridge 101C.

In some examples, referring to the combination of FIGS. 6B and 6C, the gap G may interrupt the flow path 604 with surfaces 610 that disrupt a laminar flow property of the traversing flow 606, as shown by a curled arrow in FIG. 6C representing such disruption 612 at the gap G. In some examples, the gap G may temporarily interrupt the flow path 604 with surfaces 610 that cause the traversing flow 606 to travel in a direction away from the downstream surface 602. In some examples, the gap G may interrupt the flow path 604 with an introduction of an additional incoming flow 608 that joins with the traversing flow 606, as shown in FIG. 6B.

FIG. 6D shows a desorption phase in the gap-implemented example of FIG. 6B. Desorbing media flows into the second DAC cartridges 101B and 101C through the gaps G, thereby allowing for the desorbing media to more readily enter the sorbent articles 106B and 106C located therein, thereby improving the desorption capability of the device.

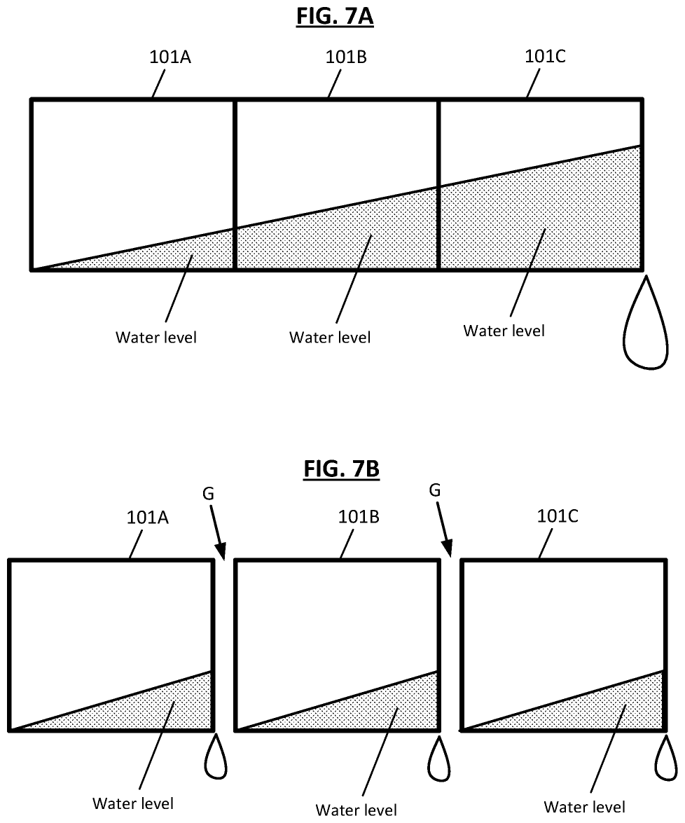

FIG. 7A is a visual representation of the amount of water or water level within each section of the DAC cartridges 101A, 101B, and 101C in the gapless concept of FIG. 6A. Any water contained within the cartridges is allowed to escape or exit the cartridge from the end of the device, as shown by the droplet. However, water level increases from one end to the other as water builds up inside the DAC device during the adsorption and desorption processes as more desorbing media flows in a predetermined direction (e.g., from left to right in FIG. 7A). For water management purposes, the end section of the last DAC cartridge 101C is left open for water inside the DAC cartridges to exit, allowing for the reduction of water level within the device.

FIG. 7B is a visual representation of the amount of water or water level within each section of the DAC cartridges 101A, 101B, and 101C in the gap-implemented example of FIG. 6B. As compared to FIG. 7A, the water level does not increase to the same level because water is allowed to exit through each of the gap (G) between the cartridges, thereby allowing for more water to exit the device to maintain a low water level throughout the cartridges during the adsorption and desorption processes. Furthermore, the rate at which water exits each cartridge in FIG. 7B is less than the rate in FIG. 7A, as shown by the smaller droplets illustrated in FIG. 7B than in FIG. 7A, due to the amount of water (or water level) being less in FIG. 7B than in FIG. 7A.

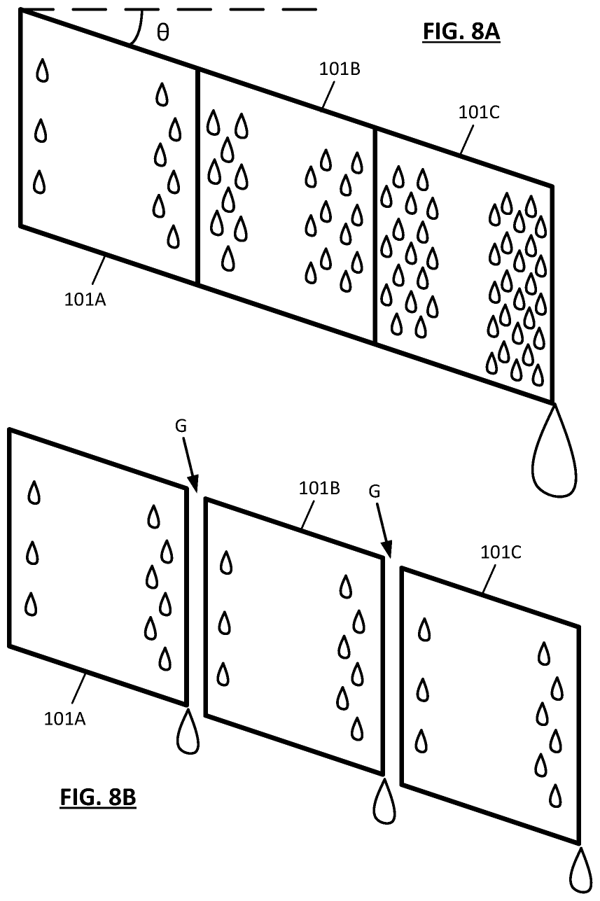

In FIGS. 8A and 8B, each of the cartridges is positioned or structured at a predetermined angle (θ) in an angled configuration. The angle may be from 1 to 5 degrees, from 5 to 10 degrees, from 10 to 15 degrees, from 15 to 20 degrees, from 20 to 25 degrees, from 35 to 40 degrees, from 40 to 45 degrees, from 1 to 45 degrees, or any other suitable range or value therebetween, with respect to the horizontal axis, which may be parallel to the ground. A steeper angle may facilitate water to pass more quickly from one cartridge to another, as illustrated. It is to be understood that although the illustrations show the cartridges as having a parallelogram-shaped configuration, any other suitable shape may be applied to form the angled configuration.

FIG. 8A is a visual representation of the amount of water or water level within each section of the DAC cartridges 101A, 101B, and 101C in the gapless concept of FIG. 6A. The angled configuration allows for water level (represented in the illustration by the number of water droplet symbols shown on each portion of the cartridges) to be varied throughout the cartridges before the water exits the device through the end of the last cartridge, e.g., the third DAC cartridge 101C. For example, the leftmost portion which is the entrance for airflow and desorbing media flow into the first DAC cartridge 101A has the lowest water level or water concentration due to the portion being the entryway and being open to the atmosphere, as well as due to the angled configuration causing the water retained to move unidirectionally, e.g., toward the right portion of the illustration. Therefore, the right portion of the first DAC cartridge 101A has greater water level or water concentration than the left portion of the first DAC cartridge 101A, the left portion of the second DAC cartridge 101B has greater water level or water concentration than the right portion of the first DAC cartridge 101A, the right portion of the second DAC cartridge 101B has greater water level or water concentration than the left portion of the second DAC cartridge 101B, the left portion of the third DAC cartridge 101C has greater water level or water concentration than the right portion of the second DAC cartridge 101B, and the right portion of the third DAC cartridge 101C has greater water level or water concentration than the left portion of the third DAC cartridge 101C. As can be appreciated, a greater concentration of water will inhibit the passage of gases through the cartridge as the water will block gaseous flows. As can also be appreciated, a blocking presence of water at the downstream end of the cartridge will restrict gaseous flow through the cartridge and create an elevated pressure gradient as the gaseous flow exiting the cartridge has a restricted passage as compared to the entry point of the gaseous flow into the cartridge.

FIG. 8B is a visual representation of the amount of water or water level within each section of the DAC cartridges 101A, 101B, and 101C in the gap-implemented example of FIG. 6B. In each gap G, water is allowed to exit the cartridge so as to facilitate faster drying of the sorbent articles disposed therein. As such, the right portion of the first DAC cartridge 101A has greater water level or water concentration than the left portion of the first DAC cartridge 101A, but the left portion of the second DAC cartridge 101B has lesser water level or water concentration than the right portion of the first DAC cartridge 101A. Similarly, the left portion of the third DAC cartridge 101C has lesser water level or water concentration than the right portion of the second DAC cartridge 101B, as shown by the water droplets illustrated in the figures, where more water droplets represent greater water level or water concentration within the portion.

In some examples, if the gapless concept (e.g., as shown in FIG. 6A) takes X minutes to increase to the predetermined temperature, the gap-implemented concept (e.g., as shown in FIG. 6B) may take X/Y minutes to increase to the same predetermined temperature, where the value of Y may vary depending upon how many entryways are present for the desorbing media. As an example, FIG. 6B shows three entryways, where one entryway is the open portion or open face of the first cartridge 101A, and the two other entryways are the two gaps G disposed between neighboring cartridges. Therefore, the predicted time that the gap-implemented concept of FIG. 6B takes may be estimated to be X/3 minutes for the temperature to reach the predetermined temperature, as compared to X minutes for the gapless concept of FIG. 6A, for example. As such, by separating the cartridges, the desorbing media may be applied in one or more locations in addition to the main entryway that is the open face of the first cartridge 101A, thereby allowing for faster heating of the DAC device.

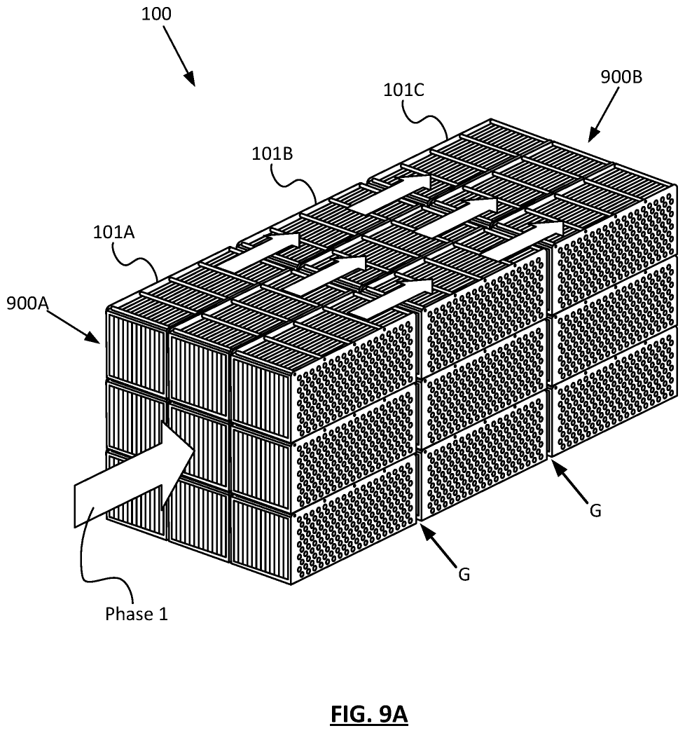

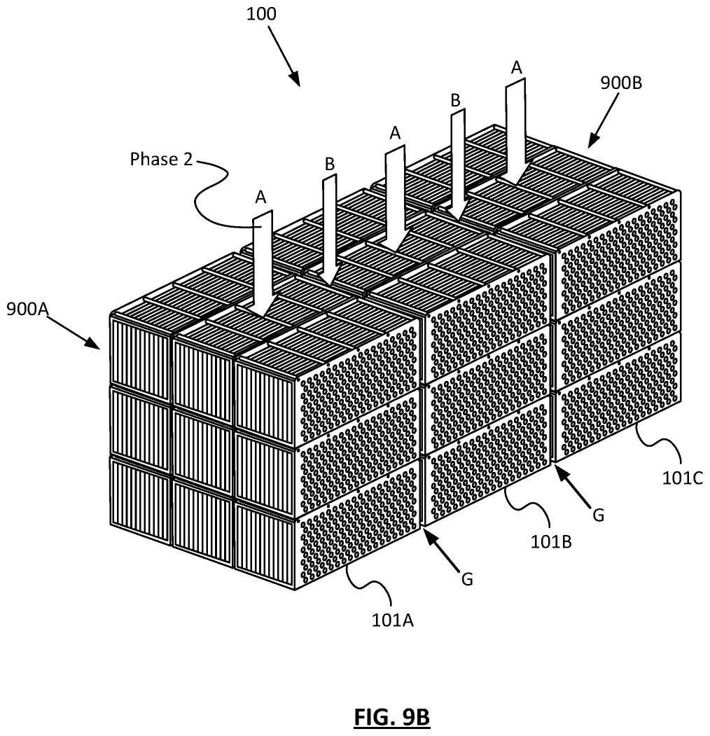

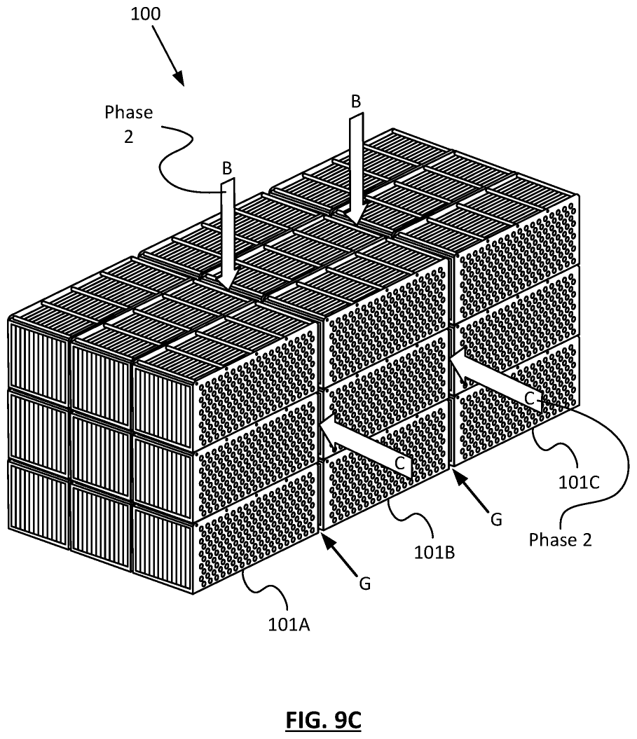

FIGS. 9A and 9B each shows an example of the DAC device 100 as shown in FIG. 5 further illustrating an airflow that is applied during an adsorption phase (FIG. 9A) or a desorption phase (FIG. 9B) as further discussed herein. For example, the DAC cartridges 101A, 101B, and 101C may be aligned along a length (L) of the DAC device 100 such that the first DAC cartridge 101A defines a front face 900A, and the last DAC cartridge 101C defines a back face 900B. During phase 1, or the adsorption phase, airflow enters the front face 900A and travels along the length (L) toward the back face 900B from which the airflow may escape the DAC device 100, as shown by the arrows extending through the DAC device 100. During phase 2, or the desorption phase, desorbing media enters the DAC device 100 in directions that are substantially perpendicular to the direction of the airflow in phase 1, as shown by the arrows. The desorbing media may enter each of the DAC cartridges 101A, 101B, and 101C directly as shown by the thicker arrows (A), or enter the gaps (G) formed between neighboring cartridges as shown by the thinner arrows (B), after which the sorbent media would then enter the sorbent articles within the respective cartridges. In some examples, the desorbing media may enter through pipes (not shown) disposed in the gaps (G) through which the desorbing media may be transported into the sorbent articles.

In some examples, a manifold (not shown) may be disposed in and/or define the gap G such that the manifold may include at least one pipe through which the desorbing media may be provided. The gap G may be of any length sufficient to cause disruption of laminar flow through the sorbent articles, or to facilitate sufficient intermixing of airflow between DAC cartridges to cause the CO₂ molecules exiting one DAC cartridge to enter a subsequent DAC cartridge in a more homogenous mixture than what resulted from traveling through the previous DAC cartridge. The length of the gap G may be defined by a component such as the manifold disposed between the DAC cartridges.

FIG. 9C shows another example in which, during phase 2, the inflow of desorbing media may occur only at the gaps G, where the desorbing media may be provided from multiple directions, such as shown by the arrows B (from top) as well as the arrows C (from the side). In some examples, the different arrows show the different pipes or channels through which the desorbing media may be provided into the gaps G, after which the desorbing media is absorbed into the sorbent articles as stored within the cartridges 101.

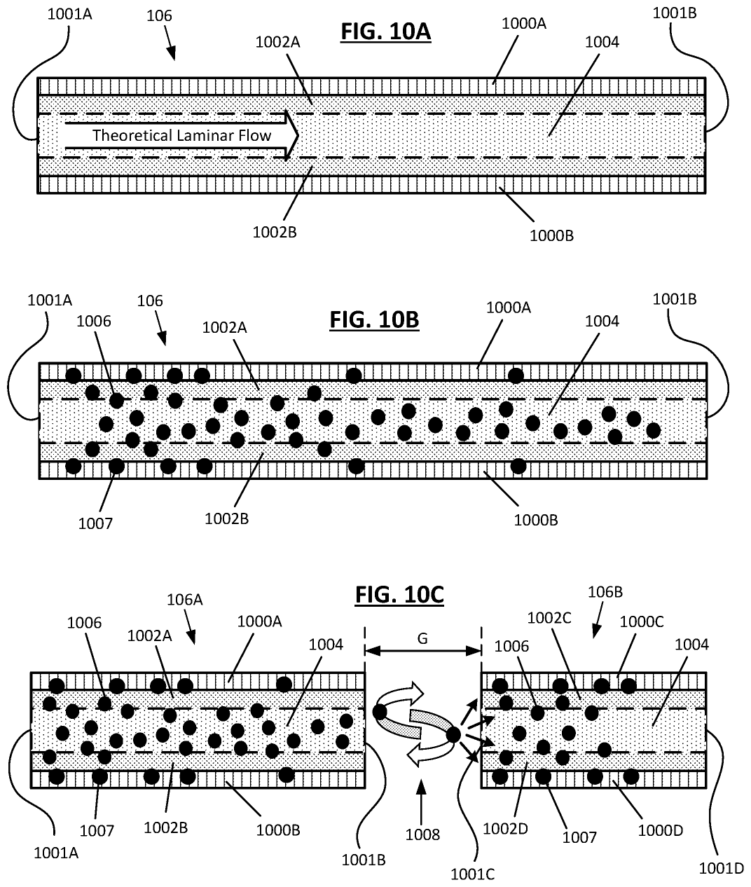

FIGS. 10A through 10C show a cross-sectional view of a spacing or channel between two individual sheets or layers of sorbent material as air including CO₂ molecules flows through the channel in a sorbent article 106, which includes multiple sheets of sorbent material. For example, between a first sheet 1000A and a second sheet 1000B, a channel 1004 is formed through which air is allowed to flow in the direction indicated by the arrow labeled as “theoretical laminar flow” in FIG. 10A. Within the channel 1004, proximal to the sheets 1000A and 1000B, are boundary layers 1002A and 1002B, respectively.

As air passes from a first end 1001A toward a second end 1001B of the channel 1004, CO₂ molecules 1006 within the air are absorbed by the sheets 1000 on both sides through the boundary layers 1002, thereby becoming absorbed CO₂ molecules 1007. However, as air passes through the channel 1004, less of the CO₂ molecules 1006 will be located at the boundary layers 1002 of the channel 1004, such that the CO₂ molecules 1006 that are further from the boundary layers 1002 remain in the airflow and unabsorbed by the sheets 1000, as shown on the right half side of FIG. 10B. As such, the saturation of absorbed CO₂ molecules 1007 decreases from the first end 1001A to the second end 1001B of the sorbent article 106, as shown in FIG. 10B. The unabsorbed CO₂ molecules will exit the second end 1001B and back into the atmosphere.

To reduce the amount of unabsorbed CO₂ molecules in the air exiting the system, the gap G is introduced in FIG. 10C between a first sorbent article 106A and a subsequent second sorbent article 106B which belong in different cartridges 101. The second sorbent article 106B is positioned such that the channel 1004 formed between the sorbent sheets 1000C and 1000D generally align with the channel 1004 between the sorbent sheets 1000A and 10001B. The gap G causes the unabsorbed CO₂ molecules exiting the second end 1001B of the first sorbent article 106A to experience a mixing or flow disturbance 1008 within the gap G such that, when air including the unabsorbed CO₂ molecules enters the channel 1004 of the second sorbent article 106B through a first end 1001C, the CO₂ molecules 1006 are then absorbed by the sheets 1000C and 1000D on both sides through the boundary layers 1002C and 1002D as shown, thereby becoming the absorbed CO₂ molecules 1007. As such, when air exits the second sorbent article 106B through a second end 1001D, there are sufficiently less unabsorbed CO₂ molecules entering the atmosphere than without the gap G. Therefore, the mixing or flow disturbance 1008 caused at the gaps G beneficially cause more CO₂ molecules to be absorbed by the sorbent articles.

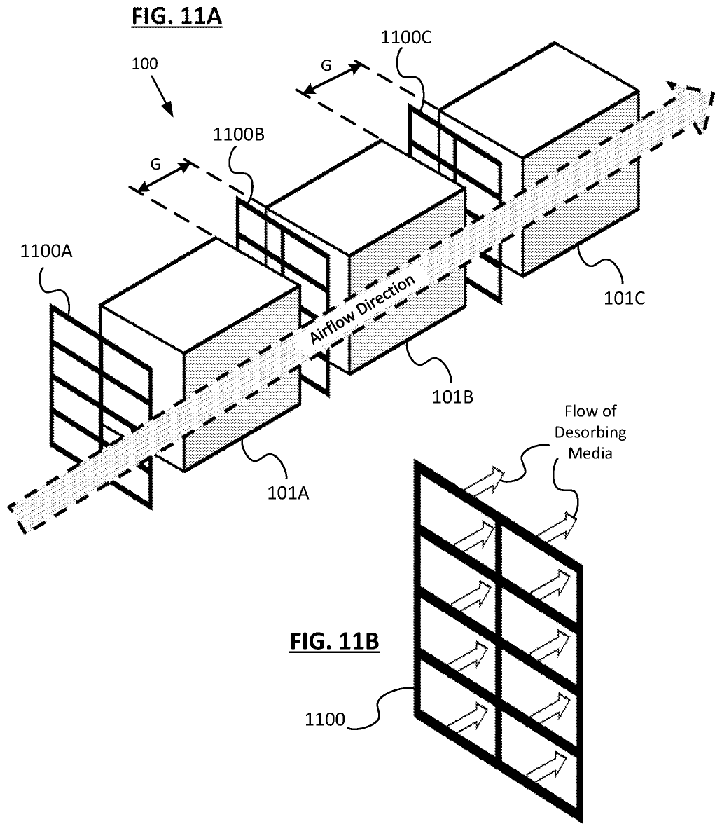

FIG. 11A shows an example of the DAC device 100 according to embodiments disclosed herein, in which desorbing media manifolds 1100 are implemented with the cartridges 101. For example, the manifold 1100A is coupled with the cartridge 101A, the manifold 1100B is coupled with the cartridge 101B, and the manifold 11000 is coupled with the cartridge 101C. In some examples, the manifold 1100 may be disposed in front of the corresponding cartridge 101 along a direction of air flow as shown, such that air flows through the manifold 1100 before subsequently flowing into the cartridge 101. In sequence, for example, air may flow through the manifold 1100A, the cartridge 101A, the manifold 1100B, the cartridge 101B, the manifold 11000, and the cartridge 101C. In some examples, the manifolds 1100 determine the distance or length of the gap G between two cartridges 101. In some examples, each gap G may have one or more manifolds disposed therein.

FIG. 11B shows an example of the manifold 1100. The manifold 1100 includes a plurality of openings or apertures at multiple locations thereof through which desorbing media such as steam may flow, such as in the direction as shown by the arrows. In some examples, desorbing media may enter the manifold 1100 through one or more points such as openings or apertures, and the desorbing media may be distributed over a broad area through the internal channel(s) of the manifold 1100 before exiting through nozzles. In some examples, the manifold 1100 may apply uniform heat to the cartridge 101 to which it is coupled.

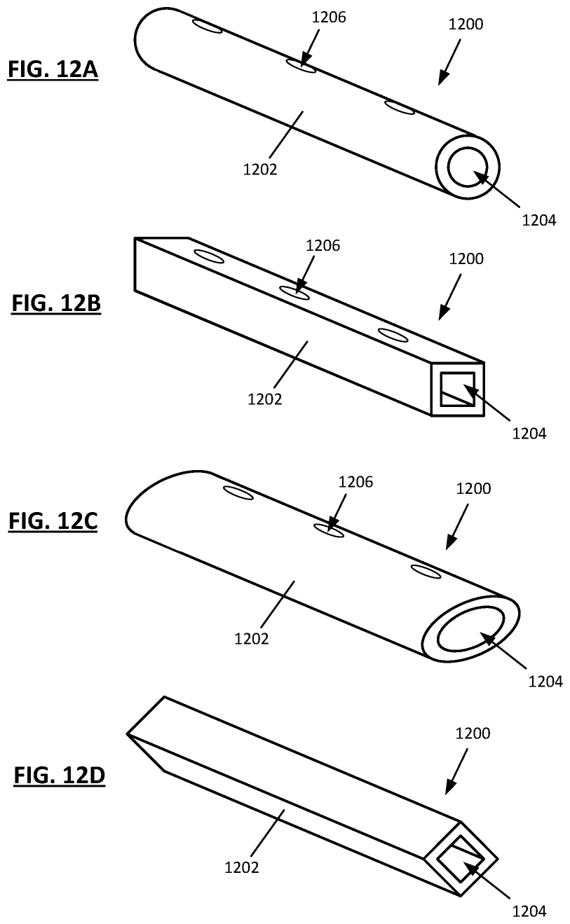

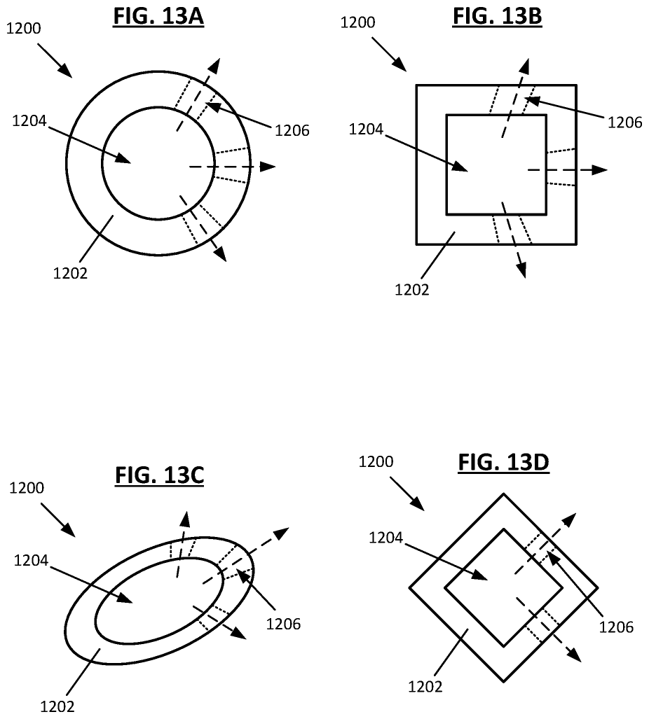

The manifold 1100 may be formed using a single component (for example, a unitary or monolithic structure) or multiple components attached or coupled together. In the case of the manifold 1100 being made of multiple components, each component may be a conduit 1200 with a channel 1204 extending through an outer structure 1202, such that the manifold may have a series of interconnected channels or conduits through which desorbing media may travel and subsequently exit in appropriate locations and directions. Examples of such conduits 1200 are shown in FIGS. 12A through 12D, whose corresponding cross-sectional views are shown in FIGS. 13A through 13D, respectively. In FIGS. 12A and 13A, the conduit 1200 has an outer structure 1202 that is substantially tubular or cylindrical, with a circular cross-section. In FIGS. 12B and 13B, the conduit 1200 has a shape that resembles a rectangular prism, with a square or rectangular cross-section. In FIGS. 12C and 13C, the conduit 1200 has an outer structure 1202 that is substantially tubular or cylindrical, with an ovular cross-section. In FIGS. 12D and 13D, the conduit 1200 is similar to that of FIGS. 12B and 13B, but having a different orientation such as in view of the openings or apertures extending through the outer structure 1202, as further explained herein.

In FIGS. 13A through 13D, the cross-sectional views of the conduit 1200 shows a plurality of openings or apertures 1206 (some of which are at least partially visible in FIGS. 12A through 12C) extending through the wall of the outer structure 1202 to allow fluid from inside the channel 1204 to flow outwardly in the directions shown by the broken arrows as illustrated. There may be one or more apertures 1206 in each conduit 1200, and in some examples, the apertures may be shaped so as to control the flow of the desorbing media to be directed generally toward the cartridge 101 that is to be heated. The manifold 1100 and the conduits 1200 may be made of thin-walled metallic materials, and the profile of the conduits 1200 may allow for sufficient volume of desorbing media while not significantly impairing airflow into the cartridge 101.

The sorbent material as referred to herein may include any suitable carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof.

Beneficially, the multi-cartridge structural frame, formed using a plurality of stacked cartridges, may allow for discretized storage of sorbent articles. For example, each individual cartridge may be separately removable or replaceable without affecting the operation of the remaining cartridges. In some examples, M/F connectors may be unplugged before sliding. In some examples, each individual cartridge may be similar to a “building block” in that the resulting multi-cartridge structural frame a modular structure that can be configured or rearranged to conform to the shape and size of the DAC reactor in which the structural frame is installed. Furthermore, beneficially, the multi-cartridge structural frame as disclosed herein may include water management features, which may facilitate water to be collected and reused as steam vapor (e.g., via heating by an external heating device) for a more self-sustaining DAC system, and/or for water to be drained more efficiently, for example using the tilted or angled configuration of the structural frame. In some examples, the multi-cartridge structural frame as disclosed herein may beneficially include integrated heating/cooling features, for example as shown in FIGS. 2A and 2B, such that cooling the steam vapor inside the structural frame beneficially facilitates efficient formation of water to be used in a subsequent adsorption/desorption cycle, and heating the collected water beneficially facilitates efficient use of the desorbing media for a self-sustaining DAC system.

### Carbon Dioxide Removal Service Providers

Also disclosed herein are methods for removing gaseous carbon dioxide (CO₂) from the atmosphere using any suitable means, methods, processes, or devices for atmospheric CO₂ removal as disclosed herein. In some examples, a carbon dioxide removal service provider that may be a person, a device, an atmospheric processing facility, a carbon dioxide removal plant, software, an internet site, an electronic interface, an organization, or a corporate agent or entity (that may include a control center, a headquarters, a data management center, an intermediary data collection or processing center, or facilitating organizations that provide information and/or control functions for or services to the provider) or an electronic device or display associated with or accessible to the provider may receive and/or become aware of information about a dispersion of a first quantity of gaseous CO₂ in the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. In some examples, the information may be in the form of an electronic communication (e.g., first electronic communication) that includes information about the dispersion of the first quantity of gaseous CO₂ into the atmosphere at the first location that may be received from and/or provided to a computing and/or electronic display device.

The carbon dioxide removal service provider may initiate an immediate or subsequent separating of or a method of separating a second quantity of gaseous CO₂ at a second location which may be different from the first location. The second location may be located remote to the first location such as, for example, when the first location is in a populated commercial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be initiated by the sending or transmitting of instructions or confirmation to a location that has the capability of performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may initiate a reporting of data regarding the second quantity that will be, is being, or has been removed from the atmosphere. The initiating may be initial steps taken to start an immediate or subsequent reporting of data that may be performed via any suitable means of electronic communication or data transmission which may be wired or wireless. In some examples, the reporting may involve the preparing of information to be included in such reporting or later reporting and the subsequent sending or transmitting of instructions or confirmation to another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may receive and/or become aware of information about a first quantity of gaseous CO₂ which may include a dispersion of gaseous CO₂. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. Such quantity may represent the amount of gaseous CO₂ being dispersed at a location (e.g., in tons of CO₂) and/or the rate of dispersion (e.g., in tons of CO₂ per minute, hour, day, etc.). In some examples, the information may be received as an electronic communication from another entity or device which sends or transmits instructions concerning gaseous CO₂ removal as disclosed herein. In some examples, an electronic communication (e.g., first electronic communication) that includes information about the dispersion of the first quantity of gaseous CO₂ that may be received from and/or provided to a computing and/or electronic display device.

The carbon dioxide removal service provider may separate or begin separation of a second quantity of gaseous CO₂ from the atmosphere, where the second quantity is at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be performed by a carbon capture device capable of carrying out any method for separating gaseous CO₂ from a gas mixture in the form of ambient air, as disclosed herein.

The carbon dioxide removal service provider may report the data regarding the second quantity that will be, is being, or has been removed from the atmosphere. The reporting of data may be performed via any suitable means of electronic communication or data transmission which may be wired or wireless. In some examples, the reporting may be in response to receiving instructions or confirmation as transmitted from another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may transmit, emit, or send out information about a dispersion of a first quantity of gaseous CO₂ into the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. The transmitting may be an emitting and/or a sending out performed via any suitable means of electronic communication or data transmission which may be wired or wireless that may not be received by the intended recipient or any recipient. In some examples, the information may be in the form of an electronic communication (e.g., first electronic communication) that includes information about the dispersion of the first quantity of gaseous CO₂ into the atmosphere at the first location that may be transmitted, emitted, and/or sent out to a computing device with such transmission, emitting, and/or sending out not necessarily being received by any recipient.

The carbon dioxide removal service provider may request an immediate or subsequent separating of or a method of separating a second quantity of gaseous CO₂ from the atmosphere at a second location. The second location may be located remote to the first location such as, for example, when the first location is in a populated commercial or industrial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. The requesting of the separating or an initiation of the separating may be performed via any suitable means of electronic communication or data transmission which may be wired or wireless. In some examples, the requesting may be by sending, emitting, or transmitting of instructions to a start command to a location that has the capability of starting or fully performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may receive a reporting, an indication of such reporting, and/or an indication of an availability of data regarding the second quantity that will be, is being, or has been removed from the atmosphere. The receiving of the reporting does not require examination or review by a human, may be achieved by simply making the reporting accessible even if subsequently never reviewed or acknowledged, and/or may be performed via any suitable means of electronic communication or data transmission which may be wired or wireless. In some examples, the receiving of the reporting may regard the second quantity, such as how much of the gaseous CO₂ was separated within a predetermined amount of time, for example within a day, a week, a month, etc. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication is received from the computing device. In some examples, the second electronic communication is received in response to the transmitting of the first electronic communication. In some examples, the second electronic communication is received from the computing or display device in response to the transmitting of the first electronic communication to the computing or display device.

As used herein, “receiving” information is to be understood as an act of “receiving” which requires only one party (or entity, device, etc.) to perform, such that a separate party for performing the act of “sending” is not required.

As used herein, “initiating” a separating (or a method of separating) is to be understood as an act of “initiating” that includes an initial or completed act of preparing or dispatching instructions to another party or device with the intent that there is an execution or start of a separating process or the association of an already started separating process with the initiating step. For example, the act of “initiating” the separating of gaseous CO₂ may cause a carbon capture device to subsequently receive an instruction, either directly or indirectly (e.g., via intermediary entities or devices) to initiate the separating, in response to which the carbon capture device operates accordingly. In another example, the act of “initiating” a separating (or a method of separating) gaseous CO₂ may include a carbon dioxide removal service provider associating carbon dioxide that has already been removed from the atmosphere (or presently in an active removal process) with a subsequent initiating of a separating. It will be appreciated that the instruction received by the carbon capture device need not be provided as part of such an “initiating” operation. Further, the act of “separating” of the CO₂, for example, is therefore not necessarily part of the act of “initiating” such separating, such as when the “initiating” of the separating is performed by a first party and the subsequent “separating” itself is performed by a second party different from the first party. Furthermore, the act of “separating” does not need to be accomplished or fully completed, either by the first party or the second party. It will also be appreciated that the act of initiating can be fully performed in one jurisdiction or country even though an acknowledgement of the initiating or an act subsequent to or associated with the initiating takes place in a different jurisdiction or country.

As used herein, “initiating” a reporting (e.g., of data) is to be understood as an act of “initiating” that includes the initial or complete act of preparing or dispatching instructions to another party to prepare, start, or complete the reporting at a later time. The act of “reporting” any data, for example, is therefore not necessarily part of the act of “initiating” such reporting, such as when the “initiating” of the reporting is performed by a first party (the initiating party) and the “reporting” itself is performed by a second party (the reporting party) different from the first party (the initiating party). Furthermore, the act of “reporting” does not need to be accomplished or fully completed, either by the first party or the second party. It will be appreciated that the act of initiating can be fully performed in one jurisdiction or country even though an acknowledgement of the initiating or an act subsequent to or associated with the initiating takes place in a different jurisdiction or country.

As used herein, “reporting” data is to be understood as an act of “reporting” which may require only one party (reporting party) to perform. Furthermore, the act of “reporting” does not require the receipt (or confirmation of receipt) of such reporting by another party (receiving party). The reporting may be a storage of the data or display of the data at a location that is accessible to an intended recipient, and may still be considered to be a reporting even when the intended recipient does not access or review the data.

As used herein, “transmitting” information is to be understood as an act of “transmitting” which may require only one party (the transmitting party) to perform. Furthermore, the act of “transmitting” does not require a receiver (e.g., receiving party) or receipt (e.g., confirmation of receipt) of the information that is transmitted.

As used herein, “requesting” a separating (or initiation of a method of separating) is to be understood as an act of “requesting” which may require only one party (the requesting party) to perform. Also, the act of “separating” which is requested by the act of “requesting” may be performed by another party (the separating party). Furthermore, the act of “requesting” may be only intended or started and does not need to be accomplished or fully completed (e.g., when no separating results from the act of “requesting” such separating). In an example, the act of “requesting” a separating (or initiation of a method of separating) of gaseous CO₂ may include a carbon dioxide removal service provider associating carbon dioxide that has already been removed from the atmosphere (or presently in an active removal process) with a subsequent request for a separating. It will be appreciated that the act of requesting can be fully performed in one jurisdiction or country even though an acknowledgement of the requesting or an act subsequent to or associated with the requesting takes place in a different jurisdiction or country.

As used herein, “receiving” a reporting or an indication of the reporting is to be understood as an act of “receiving” which does not require a sender (e.g., sending party). The receiving may be a storage of the data or display of the data at a location that is accessible to an intended recipient, and may still be considered to be a receiving even when the intended recipient does not access or review the data.

As can be appreciated, the first quantity, the second quantity, and the portion of the first quantity may be estimated or projected values. It can be further appreciated that carbon dioxide gas released or dispersed at the first location may not necessarily include or be the same CO₂ molecules separated or collected at the second location, and that the second quality may be an equivalent quantity of CO₂ that was released or dispersed. The CO₂ in the portion of the first quantity may be in a non-gaseous form. The portion of the first quantity or the second quantity may refer to carbon dioxide that is entrapped in the sorbent as disclosed herein or that has been stored or otherwise converted into another form. The portion of the first quantity or the second quantity may also include gases other than carbon dioxide. For example, the second quantity may be in a non-gaseous form or combined with other materials.

As used herein, a “carbon capture device” refers to any one or more devices as disclosed herein that is capable of separating gaseous CO₂ from the atmosphere at the location at which the device is installed or located. The carbon capture device may refer to a single device or a plurality of devices, or a facility containing therein one or more such devices or component devices that act in concert. The device may include, for example, the desorbing media source(s) and the adsorber structure(s) as disclosed herein. The device may be operable by a user or operator using an electronic device. The device may generate data associated with its operation, for example as may be detected by one or more sensors and/or as may include log data, among other examples.

As used herein, an “electronic device” is capable of performing one or more electronic operations, for example a computer, smartphone, smart tablet, etc. The electronic device may include for example a display device and/or one or more processing units and one or more memory units. The processing unit may include a central processing unit (CPU), a microprocessor, system on a chip (SoC), or any other processor capable of performing such operations. The memory unit may by a non-transitory computer-readable storage medium storing one or more programs or instructions thereon which, when run on the processing unit, causes the processing unit or the electronic device to perform one or more methods as disclosed herein. The memory unit may include one or more memory chips capable of storing data and allowing storage location to be accessed by the processing unit(s), for example a volatile or non-volatile memory, static or dynamic random-access memory, or any variant thereof. In some examples, the electronic device may be referred to as a computing device.

Technical advantages of removing gaseous CO₂ from an atmosphere using the methods or processes as disclosed herein includes, but are not limited to, facilitating a network of entities and/or devices that are capable of communicating with other entities and/or devices in order to remotely provide instructions or facilitating separation and removal of gaseous CO₂ without requiring to be physically at the location to do so. Furthermore, the methods and processes as disclosed herein provide a robust network of interinstitutional communication such that each entity (which may be an institution associated with a physical location) is capable of directing or initiating the separation and removal of gaseous CO₂ at multiple locations simultaneously, as well as having the capability of flexibly changing the location at which separation and removal of gaseous CO₂ is determined to be removed. The change in location may be performed at or near real-time such that there is minimal time lag between when the instructions are provided and when the separating of gaseous CO₂ takes place at the designated location, for example. In some examples, the methods or processes as disclosed herein provides a flexible communication network in which the entity or device which performs the separation and removal of gaseous CO₂ at the designated location may provide a timely reporting (e.g., operation summary and/or invoice for the service rendered) associated with the amount of gaseous CO₂ that was removed during a predetermined time period. Such reporting may be generated automatically or manually, may be generated at a predetermined time interval (e.g., once every day, week, month, etc.) or more flexibly as manually determined (e.g., each time a user or entity requests), or may be generated in response to achieving or exceeding a predetermined threshold, including but not limited to the amount of gaseous CO₂ that was separated and removed from the atmosphere (e.g., every 1 ton, 5 tons, 10 tons, etc., of gaseous CO₂ that was removed from the atmosphere), and any other suitable conditions as determined and agreed upon by the entities involved, for example.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A direct air capture (DAC) device comprising:
a plurality of cartridges disposed adjacent to each other and further disposed to receive an incoming flow having a first flow at a first flowrate and a second flow at a second flowrate less than the first flowrate,
wherein the plurality of cartridges include a first cartridge type having a first type of sorbent suitable for the first flowrate and a second cartridge type having a second type of sorbent suitable for the second flowrate,
wherein the first cartridge type is disposed within the plurality of cartridges to engage the first flow and wherein the second cartridge type is disposed within the plurality of cartridges to engage the second flow.

2. The DAC device of claim 1, wherein the second cartridge type is disposed at a peripheral edge of the plurality of cartridges as viewed from the incoming flow.

3. The DAC device of claim 1, wherein each of the plurality of cartridges has:
a frame structure having a plurality of first perforations facilitating a first directional fluid passage therethrough;
a plurality of sorbent articles disposed therein and supported by the frame structure; and
a plurality of conduits having a plurality of second perforations facilitating a second directional fluid passage therethrough.

4. The DAC device of claim 3, wherein the first perforations facilitate flow of air therethrough, and the second perforations facilitate flow of desorbing media therethrough.

5. The DAC device of claim 4, wherein the plurality of cartridges are disposed with gaps located between neighboring cartridges to facilitate flow of the desorbing media into the cartridges from each of the gaps.

6. The DAC device of claim 5, wherein the gaps facilitate intermixing of the flow of air to provide mixing or flow disturbance into the flow of air.

7. The DAC device of claim 5, wherein the gaps provide locations to facilitate exiting of water from within the sorbent articles disposed in the cartridges.

8. The DAC device of claim 3, wherein the cartridges are angled at an angle from 1 to 45 degrees with respect to a horizontal axis.

9. The DAC device of claim 3, further comprising a perforation control mechanism operatively coupled with the perforations of the cartridges and configured to control opening and closing of the perforations.

10. The DAC device of claim 3, further comprising a plurality of integrated flexible resistive heaters disposed between the frame structure of the cartridge and the sorbent articles.

11. A direct air capture (DAC) device comprising:
a plurality of cartridges including upstream cartridges and downstream cartridges, the upstream cartridges disposed to receive an incoming flow and to be interposed between the incoming flow and the downstream cartridges,
wherein the upstream cartridges have a first type of sorbent suitable for engaging the incoming flow and wherein the downstream cartridges have a second type of sorbent suitable for engaging the incoming flow after that flow passes through the upstream cartridges.

12. The DAC device of claim 11, wherein the plurality of cartridges further includes midstream cartridges disposed between the upstream cartridges and the downstream cartridges.

13. The DAC device of claim 12, wherein the second type of sorbent is further suitable for engaging the incoming flow after that flow passes through the midstream cartridges.

14. A direct air capture (DAC) device comprising:
a plurality of cartridges having an upstream surface receiving an incoming flow and a downstream surface through which the incoming flow exits the plurality of cartridges, the plurality of cartridges further defining a flow path extending between the upstream surface and the downstream surface, the flow path configured to receive the incoming flow and direct the incoming flow to the downstream surface,
wherein the plurality of cartridges further define at least one gap disposed between the upstream and downstream surfaces, the at least one gap defining a traversing flow between the plurality of cartridges.

15. The DAC device of claim 14, wherein the at least one gap interrupts the flow path with surfaces that disrupt a laminar flow property of the traversing flow.

16. The DAC device of claim 14, wherein the at least one gap temporarily interrupts the flow path with surfaces that cause the traversing flow to travel in a direction away from the downstream surface.

17. The DAC device of claim 14, wherein the at least one gap interrupts the flow path with an introduction of an additional incoming flow that joins with the traversing flow.

18. The DAC device of claim 14, wherein the at least one gap defines a drain that removes water from the plurality of cartridges.

19. The DAC device of claim 18, wherein the at least one gap is disposed between an upstream cartridge of the plurality of cartridges and a downstream cartridge of the plurality of cartridges, the drain being configured to equalize an upstream volume of water contained in the upstream cartridge and a downstream volume of water contained in the downstream cartridge.

20. The DAC device of claim 18, wherein the plurality of cartridges are disposed at an angle to promote a pooling of water in at least one of the plurality of cartridges.
